(19) United States
(12) Patent Application Publication
(10) Pub. No.: US 2016/0257082 A1
(43) Pub. Date: Sep. 8, 2016

(54) Pouch-type Sealant Injector

(71) Applicants: Brandon Ragan, Springfield, VA (US); Philip Ragan, Horseheads, NY (US)

(72) Inventors: Brandon Ragan, Springfield, VA (US); Philip Ragan, Horseheads, NY (US)

(21) Appl. No.: 15/144,955

(22) Filed: May 3, 2016

Related U.S. Application Data
(63) Continuation of application No. 61/932,382, filed on Jan. 28, 2014.

(51) Int. Cl. B29C 73/16; B65D 35/10; B29C 73/02; B65D 35/38

(52) U.S. Cl. CPC B29C 73/166; B65D 35/38; B65D 35/10; B29C 73/02

(57) ABSTRACT

This invention relates to a pouch injector made from a flexible and/or collapsible material. The pouch could contain a gusset that allows the pouch to free stand and allows for a greater pouch interior volume. The pouch and dispensing adapter(s) are used to dispense and/or inject a liquid, for example, into a tire through the valve stem. The invention can be used for either repairing a tire puncture and also preventing future tire punctures and leaks

### CROSS REFERENCE TO RELATED APPLICATIONS

This application is a divisional/continuation-in part/etc. of application Ser. No. 13/924,959, filed Jun. 24, 2013, entitled Pouch-type Sealant Injector, which is incorporated herein by reference.

### FIELD OF THE INVENTION

The present invention relates to a flexible and/or collapsible pouch injector for dispensing, such as for example, a fluid into a tire through its valve stem. The invention can thus be used for either repairing a tire puncture or for preventing future tire punctures and leaks.

### BACKGROUND OF THE INVENTION

The present invention solves many problems that face any type of tire repair as it relates to punctures and leaks. Applications for the invention may include: ATV's, utility vehicles, lawn and garden tractors, wheelbarrows, golf carts, bicycles and automobiles but are not limited to those listed. The invention grows out of a need for a simple way of injecting tire sealant into a tire which has either lost its air or is no longer air tight. The invention provides a disposable, cost effective method of applying a liquid such as a sealant without creating undue mess and offer a means of measuring the applied liquid. The pouch injector of the present invention was designed for the everyday user, such as lawn care professional, outdoor power sports enthusiast, small equipment operator, homeowner or casual biking enthusiast, etc. The device is capable of larger, commercial applications as well.

The pouch type container can be used to hold a variety of liquids and can be sold in a kit form with a flexible and/or collapsible pouch container and appropriate dispensing adapters. In addition to the aforementioned benefits, the pouch injector invention can be sold with an initial amount of liquid contained within the pouch. The prefilled pouch provides for easy storage in small storage compartments of various equipment and/or vehicles: cars, bicycles, ATVs, etc., allowing for “on the go” and disposable, prepackaged tire sealant in the right application amounts.

It is common for tire sealant liquids to be packed in rigid plastic bottle type containers. Said plastic bottles are not ideal for dispensing liquid through a small nozzle, for example, a valve stem of a tire. Ridge plastic bottles only compress a finite amount and require the user to compress and de-compress the bottle to allow air to replace the volume of expended liquid inside the plastic bottle reservoir in order to return the bottle back to its original form that will then allow the user to re-compress the bottle in order to continue dispensing liquid into a tire through its valve stem. Using a bottle requires the user to repeat the aforementioned compression and de-compression of said bottle numerous times in order to fully dispense the liquid contained inside the bottle reservoir. The aforementioned process is very slow and time consuming and does not allow the user to fully and completely expel the liquid inside said bottle container. The present invention proposes the use of a pouch type container with a variety of hose and/or tip adapters that are further defined later in this patent. The aforementioned pouch type container is manufactured with a flat sheet of flexible material which is sealed and/or glued on all edges to form a reservoir. The aforementioned pouch will allow the container to fully collapse and/or compress and/or fold flat. The aforementioned benefits described will allow the user to dispense a liquid in one continuous motion since the pouch will fold and collapse onto itself without needing to compress and de-compress the pouch type container. The present invention provides a faster and mess-free method of applying a liquid into a tire through the tire valve stem. Further details of the aforementioned pouch type container and adapters are disclosed later in this patent.

Prior devices such as that shown in U.S. Pat. No.5,908,145 to Jaksa show a typical system for injecting sealing fluid into a tire which includes a valve stem connector, reservoir chamber and a flexible hose connecting the two. Jaksa also shows a set of fittings that connect to a source of compressed air or pump to inject the sealant into the tire. The invention of Jaksa is both more costly than the present invention and relies on an outside agent (compressed air from a pump or compressor) to inject the sealing fluid into the tire. This is a typical construction for many of the prior art documents in this field. It should also be pointed out that the device of Jaksa makes no provision for servicing both Schrader and Presta type valve stems. The U.S. Pat. No. 5,012,954 to Will shows a tire inflation system using a compressed gas to fill a tire with air. Will does not make any attempt to fix a puncture but rather a way of inflating a brand new tube when positioned within a tire.

### OBJECTS OF THE INVENTION

It is an object of the present invention to provide a simple device for applying a fluid from a flexible, collapsible container into a restricted or enclosed space, especially through a normally closed valve or other restriction through a hose or spout.

It is an object of the present invention to provide a simple device for injecting tire sealant into a tire through the valve stem that is disposable, cost effective, less messy and offers a means of measurement.

It is another object of the present invention to provide a way of sealing a puncture/leak in a tire without wasting tire sealant and also providing a way to measure and control the amount of sealant being injected into a tire through the valve stem for tire repair or flat prevention.

It is a further object of the invention to allow for all skill levels of users to effectively use the invention and not require external sources for successful application of tire sealant.

Another object of the invention is to hold a variety of liquids that can be sold in a kit form with dispensing adapter(s) (further defined later in this patent). The pouch injector invention can be sold with the initial amount of fluid contained inside the pouch for easy storage in a ready to use form enabling flat tire repair even while on the go.

It is a further object of the invention to provide a compact, highly transportable packaging of fluid such as tire sealant to be applied to a tire in a remote location such as the middle of an extended bike trip without requiring additional tools or complicated processes.

### SUMMARY OF THE INVENTION

The invention according to at least one aspect is an improved device for injecting tire sealant into a punctured or leaking tire. While the use of tire sealant liquid is considered to be the main purpose of the invention, it is in no way limited to this particular application. Any liquid which is capable of being dispensed into a tire or other enclosed space through a valve can be used with the present invention. However, for simplicity, the invention is described in an example of applying tire sealant to fix a flat tire, but the invention should not be limited to such example.

The injection of tire sealant can be a puncture/leak preventative as well as used to fix a flat tire. The device of the present invention makes the addition of tire sealant quick and easy. The present invention according to at least one aspect is concerned with injecting a liquid into a tire through a valve stem. The tire must then be filled with air (or similar gases) by any known conventional way such as manual pump, portable or stationary air compressor, etc. The present invention can easily be used with any pneumatic tire comprising a valve stem, including but not limited to: ATVs, utility vehicles, lawn and garden tractors, wheelbarrows, golf carts and even automobiles. The present invention is for use primarily with tubeless tires but can also be effective in applying a liquid into the tubes or tires having inner tubes.

The present invention consists of a preferably flexible and collapsible pouch-container comprising a reservoir that holds a liquid, wherein the pouch can be paired with any permutation of dispensing adapters. The dispensing adapters can include a spout/cap type dispensing apparatus connected to a flexible tube at one end and on the other end of the flexible tube to a valve stem connector. The valve stem connector, while necessary for injecting tire sealant into a tire, can be replaced with any other type of tip or with the hose only without using a connector, for the purpose of dispensing liquid into a tire through the valve stem. When injecting tire sealant, one key element of the invention is the ability to dispense the contents of the pouch into the tire through its valve stem without wasting tire sealant while also providing a way to measure and apply a controlled amount of liquid into the tire. Another key element of the present invention is pairing the use of a flexible and/or collapsible pouch/bag with a dispensing adapter(s) for the purpose of dispensing a liquid into a tire through its valve stem. The present invention is versatile enough to work on virtually any type of pneumatic tire and is adaptable to be used for other liquids that require dispensing into a tire through a valve stem.

### DEFINITIONS

For the purposes of this application, unless otherwise expressly indicated, a “pouch” shall mean one or more sheets of flat flexible material that is/are sealed (e.g., by heat, glue, etc.) on one or more edges for the purpose of mending the flat plastic sheet together to form an inflatable/fillable reservoir and which can be flattened to a nearly planar state when not in use.”

And for the purposes of this application, unless otherwise expressly indicated, “collapsible” shall mean the “capacity (of the object described) to be folded into a small space.”

### BRIEF DESCRIPTION OF THE DRAWINGS

FIG. 1 is a perspective view of a pouch according to at least a first embodiment of the invention.

FIG. 2 is a diagrammatic view of a pouch according to at least a second embodiment of the invention.

FIG. 3 is a diagrammatic view of a pouch according to at least a second embodiment of the invention with the adapter removed.

FIG. 4 is a diagrammatic view of a pouch according to at least a second embodiment of the invention showing a partial cross-section of the pouch and adapter(s).

FIG. 5 is a diagrammatic view of a pouch injector configured to repair a tire.

FIG. 6 is a diagrammatic view of a pouch injector in use repairing a tire.

FIG. 7 is a diagrammatic cross-section of a pouch according to at least another embodiment of the invention.

FIG. 8 is a diagrammatic cross-section of a series of adapters for use with a pouch according to one embodiment of the invention.

FIG. 9 is a diagrammatic view of a compression tool in use on a pouch according to at least one embodiment of the invention.

FIG. 10 is a second diagrammatic view of a compression tool in use on a pouch according to at least one embodiment of the invention.

FIG. 11 shows a pouch according to a further embodiment of the invention having a different size than the first embodiment.

FIG. 12 shows a pouch having an alternate shape.

FIG. 13 shows a pouch having an alternate shape and size.

FIG. 14 is a diagrammatic, partial cross section of a pouch for transporting various fluids with the spout in a stored position

FIG. 15 is a diagrammatic, partial cross section of a pouch for transporting various fluids with the spout in an extended position.

FIG. 16 is a diagrammatic, environmental view of the pouch for use in filling a vehicle with gasoline.

FIG. 17 is a diagrammatic view of a pouch according to a further embodiment of the invention having a reversible adapter.

Similar reference characters denote corresponding features consistently throughout the attached drawings.

### DETAILED DESCRIPTION OF THE PREFERRED EMBODIMENT(S)

The invention may include a pouch, namely, a bag-type pouch for containing a liquid which is made from a flexible and/or collapsible material such as a metal, alloy or plastic foil material. Common materials used for such a pouch may include, but are not limited to, PET/LLDPE, BOPP/CPP, PA/LLDPE, PET/PET/LLDPE, PET/PA/LLDPE, PET/MPET/LLDPE, PET/AL/PA/LLDPE, PET/AL/PA/RCPP. The pouch may contain or be connected to any number of permutations of spouts and/or hoses and/or tips (or any combination thereof) at the pouch opening to connect a variety of common valves and the like. The pouch may be used to dispense a liquid into a tire through its valve stem.

Dispensing Adapters: An apparatus that is internalized and/or built into the pouch opening for the purpose of dispensing a liquid into a tire through a valve stem, or an apparatus that is attachable to the pouch opening and/or fitment for the purpose of dispensing a liquid into a tire through a valve stem.

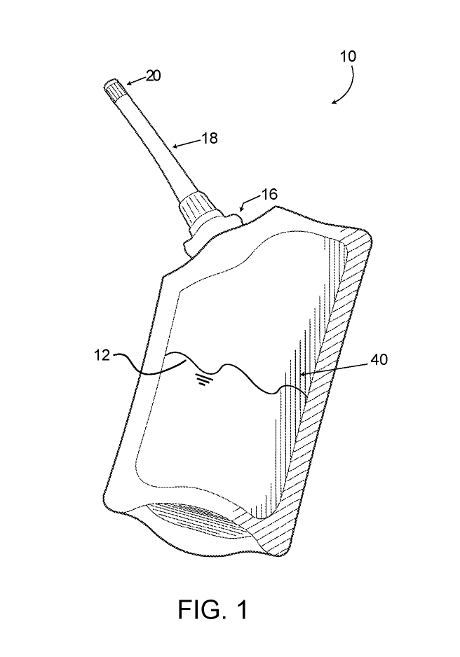

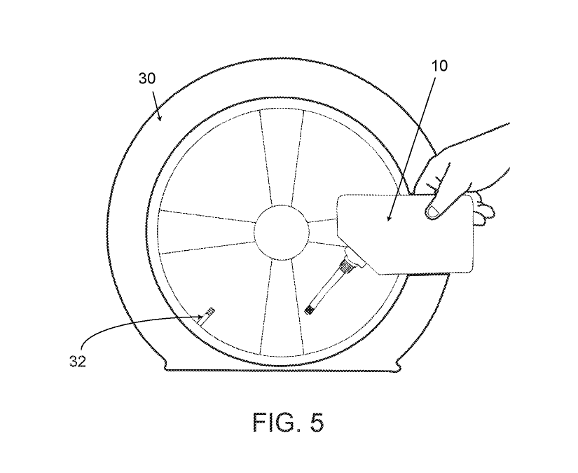

As best shown with reference to FIG. 1, the invention relates to a pouch injector 10 for dispensing tire sealant (or any other liquid) 12 into a tire or the like. The present invention uses a pouch-type container comprising dispensing adapter(s), which can include a pouch fitment/opening 16 connected to a flexible tube 18, which is in turn attached and/or connected to a connector tip 20 for the purpose of dispensing a liquid into a tire 30 (FIG. 5) through a valve stem 32. The design of the pouch features collapsible/flexible walls 40, which when compressed forces the fluid located within the container through the container opening 16, tube 18, through the connector tip 20 and through a valve stem 32 into a tire. Exerting any type of squeezing and/or compressing force upon the flexible/collapsible pouch container 10 will result in the pouch collapsing and folding onto itself which will force the liquid out of the pouch opening in one continuous motion. The connector tip 20 can include a number of permutations of connectors for specific mating with Schrader valves and/or Presta valves or can contain both Schrader and Presta adapters or any connector used for the purpose of attaching and/or connecting to a valve stem or the like.

The connector tip 20 of the pouch injector can attach to and/or thread onto a tire valve stem 32. The connector tip is attached to the pouch opening 16 with any permutation of rigid and/or flexible hose/tube 18 and/or cap/spout/fitment or otherwise extending from the pouch opening to a pneumatic tire valve stem. For threaded connector tips, there are two common types of valve stems, namely Schrader valves and Presta valves, which are used on pneumatic tires. The Schrader valve consists of a valve stem into which a valve core is threaded. This type of valve is used on virtually all pneumatic tires. The Presta valve by contrast is less common, except on higher quality bicycles. The Presta valve does not require a valve spring in its core as it relies on the pressure differential within the tire and the exterior for biasing the valve closed. A pump having a Presta adapter or the like typically directly apply a force (through a pin or the like) to manually move the valve to an open position while tire is being inflated, and then air pressure from within the tire acts on a valve surface to close the valve when the adapter is removed.

The threaded connector tip of the injector device according to the invention can preferably be provided with sufficient adapters to thread onto either a Schrader or Presta valve. The connector tip preferably does not require a valve core release pin, since the valve core (including the pin) are preferably removed prior to filling a tire with sealant. The absence of a valve core release pin allows the fluid to pass through the valve stem more easily and prevents fouling of the valve and valve seat. The connector tip (without a valve core release pin) could include a Schrader thread by itself or a Presta thread by itself or both, as outlined in U.S. Pat. No. 7,047,841 issued May 23, 2006 to Ragan, which is incorporated herein by reference. The poppet valve (also called mushroom valve or valve core) is a valve consisting of a hole, usually round or oval, and a tapered plug, usually a disk shape on the end of a shaft.

### Measurement

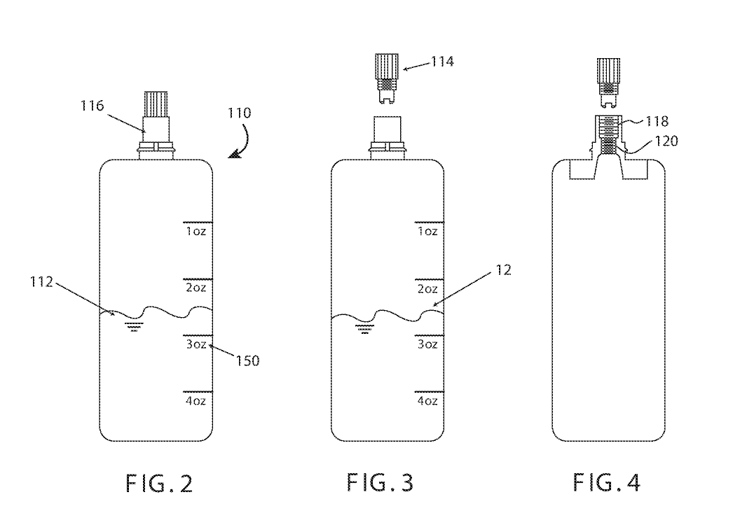

As shown in FIGS. 2-4, the present invention allows for a premeasured amount of liquid for a given application to be dispensed easily through the pouch opening, dispensing adapter(s) and tire valve stem. The pouch 110 can include a number of marked indicia 150 spaced along the length of the pouch indicating the volume of fluid 112 within the pouch. The volume indicators can be used to either indicate the amount of fluid left within the pouch or to measure the amount of fluid applied while the fluid is dispensed through the applicator spout 116. The pouch may be partially translucent to allow the fluid levels to be more readily determined, but the pouch may also be opaque. Since the pouch is flexible and collapsible, the user could simply squeeze a closed container of fluid to move the fluid to one end. The user would be able to see from the shape of the pouch where the fluid level was relative to the measurement markings on the pouch to determine the currently contained volume of fluid.

The spout 116 can include threads 118,120 sized to mate with a Schrader 118 and/or Presta valve 120. A second adapter can be attached to the spout 116 to thread to other types of valves as well, but preferably a cap 114 having a valve removal tool is provided threaded to the spout 116 for safe keeping of the tool 114 and to seal the end of the spout. Alternatively, the pouch could permanently have affixed one adapter of the Schrader, Presta or other known type, wherein the user would select a pouch for use with the type of valve on the tire to be repaired.

In this way, the pouch can be adapted to many applications. The applications can include, but is not limited to, ATVs, utility vehicles, lawn and garden tractors and equipment, wheelbarrows, golf carts, and even automobiles. Premeasured amounts can be sold within the pouch injector for simple and disposable tire sealant application. Bottle type containers currently sold by contrast do not offer a method of accurate measurement with application into multiple tires.

### Mess-Free and Leak-Free

The closed system created by the pouch and dispensing adapter(s) prevents mess, waste and/or spillage of the enclosed liquid while dispensing desired amounts easily into a tire through a valve stem. The connector tip and/or dispensing adapter(s) of the present invention form a leak-free connection with the valve stem. Bottle type containers do not provide a secure connection to the valve stem for a mess-free and leak-free application.

### Storage and Application

A further advantage of the present invention is its ability to be easily stowed in small storage compartments of various vehicles and/or equipment (examples: cars, bicycles, ATVs, golf carts) for ready to use tire repair. One preferred storage location is the emergency kit of a bicycle, often stored below the bike saddle, where space and weight is at a premium. The pouch injector of the present invention is made from a flexible and/or collapsible material, which is cost effective, disposable and inexpensive to ship. This flexible pouch allows for easy application as the pouch housing material will collapse while compressing and/or squeezing for seamless injection of a liquid. Traditional means of sealant application with a bottle is time consuming, cumbersome and it creates a mess as sealant can leak and spill from the valve stem without a secure, leak-free connection to the valve stem.

### In Operation

As best seen with reference to FIGS. 1 and 5-7, the operation of the invention shall now be described. A user may desire to fix a flat tire, for example, during a bike ride or before using machinery stored for a long period in a garage, etc. The cause of the flat may be a leaky inner tube (not shown) within a tire or it may be the tire 30 itself. The user will then retrieve one or more pouches 10 containing an amount of sealant 12 for use in sealing a hole or other puncture in the tire. The pouch may be conveniently stored, for example, in the emergency tool pouch underneath the saddle of a bicycle, glovebox of a vehicle or in other locations.

The user must then determine the type of valve on the valve stem 32 on the tube or tire. Typically, this will be a Presta or Schrader valve, but could be other types, such as for example on the inflation stem of a raft. The user must then attach or configure the adapter(s) on the spout of the pouch so that it will mate properly with the valve stem of the tire. A specific adapter may be required as the diameter and threading on the various types of valves are dissimilar from each other.

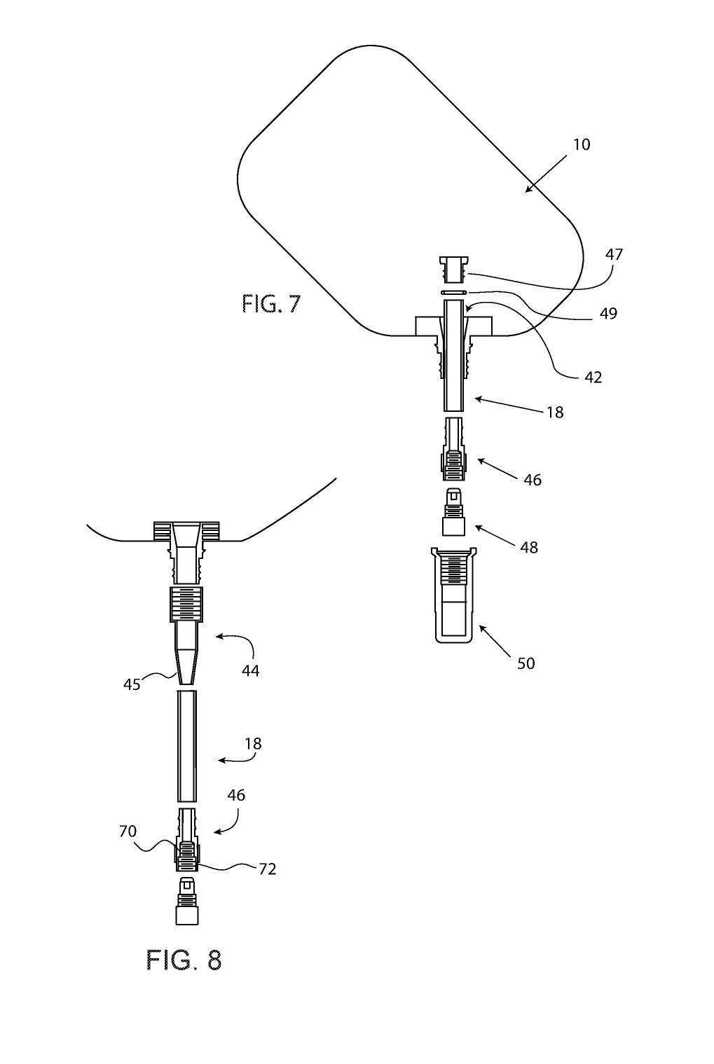

As shown in FIG. 7, the pouch 10 may include one or more adapters for mating with a particular valve stem 32. The main port or opening 42 of the pouch may have a hose or spout 18 extending from the pouch. The hose may be anchored by a retainer 47 for preventing the tube from being pulled out of the pouch. An o-ring 49 or the like may also be fitted around the hose for “wiping” the hose so that the sealant on the outside of the hose does not exit through the mouth 42 of the pouch when the hose is pulled from within the pouch to an extended position. The spout 18 may be retractable within the pouch for easy storage. A Schrader adapter (or Presta adapter or combined Presta/Schrader adapter) 46 may be insertable within the spout or may be otherwise attached to the spout for example by threading one to the other. Alternatively, the spout may be formed with an integral Schrader valve permanently attached (See for example FIG. 4). The Schrader valve adapter threads to or otherwise attaches to the Schrader valve stem to provide a seal to a Schrader valve stem, and said adapter may or may not include a pin to depress the valve pin of the Schrader valve as the adapter is threadedly attached over the valve stem. Preferably, the adapter is pin-less, meaning that no valve pin depression tool is necessary, as the user will remove the valve pin prior to attachment of the adapter for reasons that will be explained further hereinunder.

In a preferred embodiment, the adapter as shown in FIG. 7-8 has internal threads 70,72 for mating with both a Schrader valve and a Presta valve. A Presta valve has smaller diameter threads and can be inserted into the adapter 46 until it mates with threads 70. A Schrader valve has larger diameter threads than the Presta valve, and can mate with the larger diameter threads 72. Since the adapter does not need a pin tool for depressing the valve body of the valve, the relative position of the valve stem within the valve adapter is less critical and a single adapter can be used for either Presta or Schrader valve stem.

Alternatively, a single Presta or Schrader valve adapter could be used in place of the combined adapter 46. The spout may be connected to a Presta or Schrader valve adapter sized and adapted to mate with the threads of or seal over the outer walls of a particular valve. The valve adapter may be threaded to or otherwise connected directly to the spout

Additionally, as shown in FIG. 8, a general purpose spout 44 could also be used for applying sealant in non-standard or non-threaded applications. The spout 44 generally has a tip 45 that can be inserted within or over any tubular conduit (such as a valve stem) and sealing relies on continuous pressure of the tip 45 into the tubular conduit (not shown). While potentially less desirable and messier, the spout offers a wider range of potential applications in addition to the Schrader or Presta adapters. A tube/hose 18 can be inserted downstream of the spout 44, which can then be attached to a Schrader and/or Presta adapter as discussed above. Alternatively, the tube 18 could be sized to directly fit over or be inserted into a valve stem or other application site for application of fluid from the pouch. O-rings or other seals could be used on the spouts, adapters or tubes to improve the seal between the injector and the valve stem or other application site, especially where threaded connections are not feasible. These adapter permutations as well as other combinations of the adapters, spouts and tube could be used depending on the desired application and the parameters needed to efficiently apply the fluid.

A cover 50 may be provided to cover over all of the adapters when not in use. A cap 48 may also be used to seal the end of the tube. The cap 48 may include a valve tool for unscrewing the valve core of the valve stem. One skilled in the art would appreciate that the pouch could be originally sealed after the addition of the liquid sealant and that it may be required to breach this seal prior to application of sealant through the spout and/or adapters. The cover may be used to reseal the pouch after the initial breach of the seal on the pouch to keep the sealant viable for further applications.

Once the user has identified the valve type on the tire 32 and arranged the pouch to terminate in a proper mating adapter, the user must then prepare the valve stem for application. The user preferably next removes the valve core including the elements of the poppet valve of the valve stem, namely the pin and valve body, as described in U.S. Pat. No. 7,047,841 issued to Ragan et al. on May 23, 2006. The poppet valve is typically threaded within the valve stem and has a pin and a disk or conical body at the end that cooperates with the valve seat to selectively seal the valve stem to maintain the air pressure with the tire. An adapter or the cap 114 (FIG. 3) may include a valve removal tool for aiding in removing/unscrewing the valve core. Removing the valve core operates both to increase the throat diameter of the opening to the tire to increase flow rates and also protects the elements of the valve core from the sealant. This allows for more rapid filling of the tire and prevents the sealant from drying on critical valve components which could interfere with proper operation of the valve after the sealant is applied.

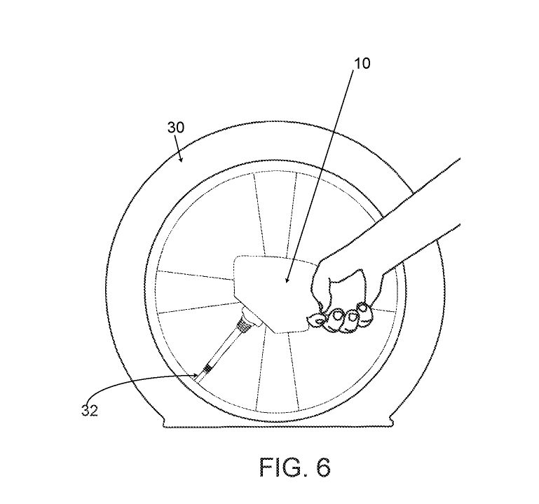

The user then threads the appropriate valve adapter 46 threads over the valve stem (see FIG. 6) or otherwise forces the adapter over the application site. The pouch 10 is then squeezed until the right amount of fluid 12 is applied within the tire. Because the pouch is flexible and collapsible, the pouch may be continually squeezed until the proper amount of sealant is dispensed, unlike more rigid containers that require the reintroduction of air (i.e., requires several “pumps” of the bottle) in the spout to replace the expended sealant volume before additional fluid can be dispensed.

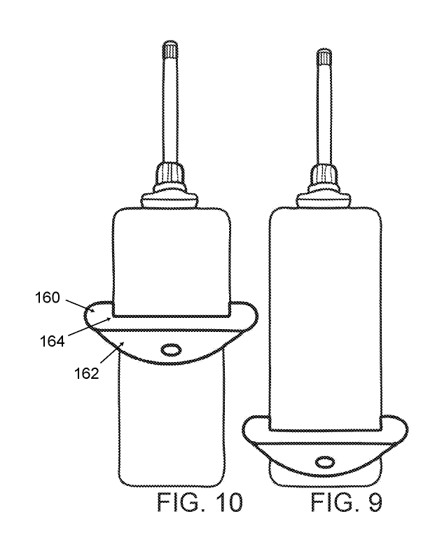

To further facilitate dispensing fluid from the pouch, a compression tool 160 (FIGS. 9-10) may be used to force fluid towards the opening. The tool operates analogously to a toothpaste tube compression tool (see “Squeeze-a-tube™”) as shown in U.S. Pat. No. 5,501,369 to Tal. The tool preferably has a handle 162 and a central opening 164 in which the pouch is inserted. By angling the tool 160 relative to the longitudinal axis of the pouch, the effective height to the pouch opening is reduced. In this orientation movement of the tool by its handle 162 along the length of the pouch causes fluid within the pouch to be pushed ahead of the tool and towards the opening. This allows for more fluid to be efficiently expelled through the pouch. Additionally, it may be easier to see the amount of fluid being displaced using such a tool, as the user merely need to slide the tool from one measurement line to the next to dispense a preset amount of fluid. One skilled in the art would appreciate that other tools may be used to squeeze the pouch and the invention is not limited to the use of any such tool.

It may be necessary to rotate the tire before or after application so that gravity causes the sealant to travel to the location of the puncture, leak or other breach in the tire. The sealant then dries over the hole to provide an air tight seal at the location of the leak so that the tire will hold air again. Multiple applications may be needed to make the tire air tight depending on the number of breaches, the consistency of the sealant, temperature or other factors. Additionally, the sealant may be applied as a preventative against potential future punctures, and larger quantities of the sealant may be required to be applied in one or more applications. Once the sealant has been applied, the cover 50 may be re-secured to the pouch to prevent premature setting of sealant within the pouch, or the pouch and leftover sealant may be disposed of as needed.

### Alternative Embodiments

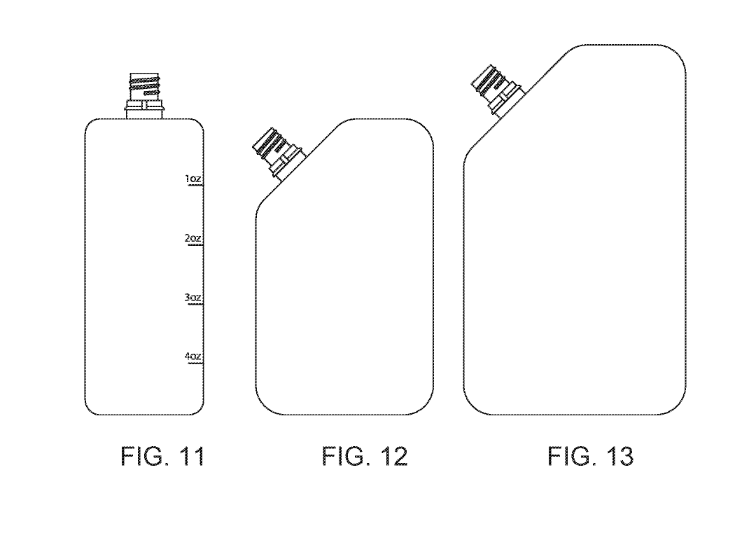

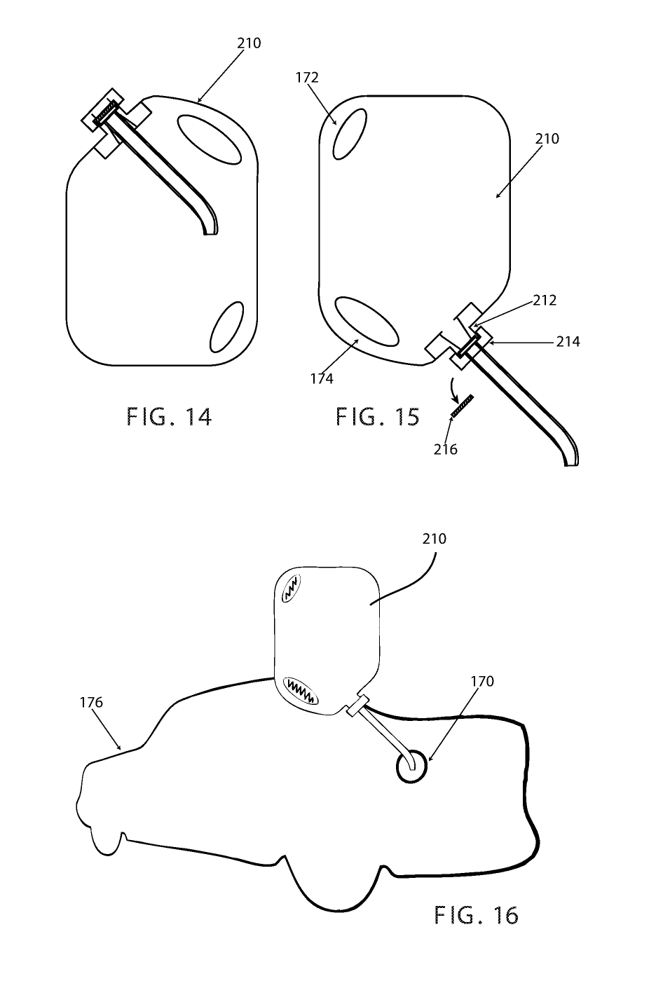

The pouch 10 may be provided in a number of sizes, shapes and volumes (FIGS. 11-13) depending on the application and the volume of sealant desired within a pouch. Additionally, the invention is not limited to the application of sealant to a tire, but may more generally be used to apply a fluid (or slurry, etc.) from one closed conduit to another container through a small opening or other restriction. One such example is shown in FIGS. 14-16. In this case a container 210 is provided for containing emergency fluids such as water (e.g., for drinking or for a radiator, etc.) or gasoline or other fuel or fluid. The pouch could be conveniently stored in the user's vehicle for such an emergency or could be sold by a gas station as a low cost container to customers who run out of fuel. When a user runs out of fuel, an emergency pouch formed of preferably a flexible, collapsible material may then be filled with gas for transportation to a stranded vehicle. The opening 212 of the pouch may include a wide lid 214 covering a spout 217. The lid preferably has a hole for selectively receiving the spout therethrough, and a disc 216 may be provided between the lid and the spout when the spout is in the stored position (FIG. 14) to perfectly seal the container as is known in the gasoline can art. With the lid and spout removed, the opening 212 is preferably sized to accept the nozzle of a gasoline pump/dispenser nozzle therethrough.

Once filled, the spout is returned to its stored position and the lid and sealing disc are replaced on the pouch to seal the gas within the pouch. The pouch is then transported to the place of use, where the spout is inverted and placed through the lid. The lid then is threaded over the opening (FIG. 15) with the sealing disc 216 removed to provide a sealed flow of gas from the pouch to the spout. The spout may then be inserted in an automobile gas filler neck 170 to provide sufficient gas to at least drive to a gas station. If desired, a vent port (not shown) may be provided on the pouch to allow for air to fill the vacuum created as gas is withdrawn from the pouch to aid in dispensing fluid from the pouch. Additionally, the pouch could be punctured at a point remote from the opening 212 to provide a vent port. Handles 172, 174 could be provided on the pouch to assist in carrying the pouch or to hold the pouch while dispensing fuel to a vehicle 176.

The extendible hose dispensing adapter is thus not limited to the function of dispensing tire sealant into a tire. The extendible hose dispensing adapter can be used for other purposes when paired, for example, with a flexible and/or collapsible container pouch. The aforementioned dispensing adapter could be used for the purpose of dispensing adhesives, silicones, paint or any liquid that need dispensing with the added function of directed application. For example, the extendible hose used with a pouch container for containing and dispensing adhesive caulk. The aforementioned is beneficial for directed application of said adhesive caulk into and/or onto an object and/or surface. The directed application includes but is not limited to hard to reach areas like a cracks or crevices. When trying to apply a liquid into a tight crack or crevice an extendable hose is beneficial to extend the reach of the liquid being applied. The aforementioned extendable hose also has the further benefit of packaging a liquid product into the same container that can be used to dispense and/or apply the liquid product. A further benefit of the aforementioned extendable hose is allowing the extendible dispensing hose to be stored and resealed inside of the pouch for the purpose of preservation of any encompassing liquid. The aforementioned extendible dispensing adapter can be repressed inside the pouch and can be reclosable with a covering cap that threads back onto the pouch opening or fitment. The said covering cap provides a seal of the extendable hose and any product contained inside said pouch opening or fitment that aids in preserving the life of the product sealed within. An even further benefit of the aforementioned extendable hose is that the injector and its components have a smaller product container footprint when the hose is repressed into the pouch. While the extendable hose is repressed inside the pouch, it allows for easier shipping and/or transportation and/or storage of any contained liquid. The alternative to the aforementioned extendable hose would be a static hose attached to the pouch creating a taller and/or wider stance and taking up additional space which can impede on the ability to store or ship or otherwise transport said pouch that requires a hose for the purpose of dispensing a liquid.

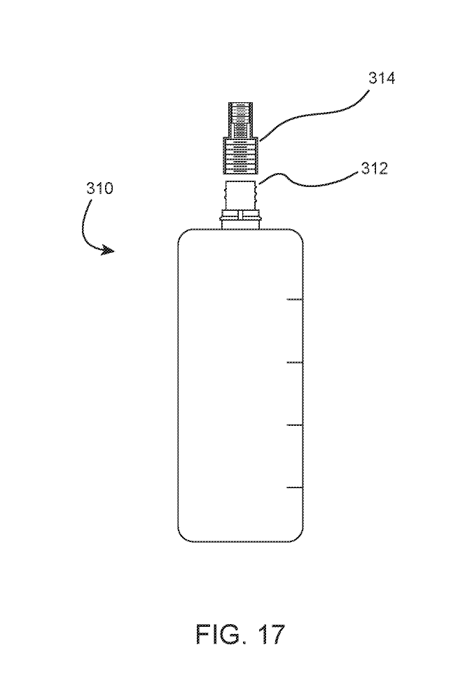

FIG. 17 shows an additional embodiment of the invention. A flexible, collapsible pouch 310 having a mouth 312 at one end of the pouch. A spout 314 is provided that is configured to either be a Presta valve, Schrader valve or a combination thereof (as described with regard to FIG. 4, for example). As shown in the drawings, the adapter 314 can be mounted over the mouth 312 of the pouch for use with a Presta valve or with a Schrader valve. The adapter allows for a simpler pouch to be used with a detachable spout to provide a compact unit with the flexibility of adapting to different types of valve stems.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims. It is therefore to be understood that the present invention is not limited to the sole embodiment described above, but encompasses any and all embodiments within the scope of the following claims.

1. A pouch for applying a liquid, comprising:
a collapsible and flexible pouch housing for containing an amount of fluid;
an opening defined in the pouch;
an adapter in fluid communication with the pouch opening for applying fluid from the pouch to a desired location.

2. The pouch of claim 1, wherein said adapter is selected from one of the group of a Presta valve and a Schrader valve adapter for mating with a valve stem of one of a tire or of an inner tube.

3. The pouch of claim 2, wherein said fluid in said pouch is a sealant.

4. The pouch of claim 1, wherein said adapter includes a spout/cap, a tip attached to the pouch opening for the purpose of dispensing a fluid into a tire through a valve stem.

5. The pouch of claim 4, wherein said tip comprises of a connector tip containing any one or more from the group of a Schrader valve adapter, a Presta valve adapter for attaching to a valve stem to dispense a fluid into a tire through a valve stem.

6. The pouch of claim 1, wherein said adapter includes a hose for the purpose of dispensing a liquid into a tire through a valve stem.

7. The pouch of claim 1, wherein said adapter includes an extendable hose that is stored within said pouch and extends through the pouch opening for dispensing a liquid into a tire through a valve stem.

8. The pouch of claim 7, wherein said hose has an interior diameter sized to closely seal with said valve stem when said hose is connected over said valve stem.

9. The pouch of claim 7, wherein the pouch opening and the hose are configured such that the opening wipes and/or squeegees the hose as the hose is extended outside the pouch.

10. The pouch of claim 7, wherein said hose comprises a connector tip containing one or more of the group of a Schrader valve adapter, a Presta valve adapter, or both a Schrader and Presta valve adapter, and a connector tip, for attaching to a valve stem for the purpose of dispensing a liquid into a tire through a valve stem.

11. A tire sealant injector for injecting sealant into a tire, the tire sealant injector comprising:
a sealant reservoir having a chamber for receiving tire sealant, said chamber having an inside and an outside surface, said chamber having an axial length;
a tubing connector positioned at one end of said chamber;
a length of tubing having a first and second end, said first end being attached to said tubing connector;
a valve stem connector having a length, said valve stem connector having an internal bore through said length, said internal bore having a first set of female threads and a second set of female threads located within said internal bore, said first set of threads being Schrader threads and said second set of threads being Presta threads;
wherein said reservoir is formed by a flexible, collapsible bag so that the entire contents of the reservoir can be expelled from the reservoir in one continuous compression of the flexible, collapsible bag regardless of the amount of fluid in the reservoir;
whereby tire sealant is dispensed through said tubing connector, tubing and valve stem connector into a tire through a valve stem by compressing said bag.

12. A fluid injector for injecting fluid into an opening, the fluid injector comprising:
a fluid reservoir having a chamber for receiving fluid, said chamber having an inside and an outside surface, said chamber inside surface defining an interior space;
a length of tubing having a first and second end, said first end being in fluid communication with the interior space of said chamber;
a tubing connector for connecting said tube to a valve stem of one selected from the group of a tire and a tube;
wherein said reservoir is formed by a flexible, collapsible pouch so that the entire contents of the reservoir can be expelled from the reservoir in one continuous compression of the flexible, collapsible pouch regardless of the amount of fluid in the reservoir;
whereby tire sealant is dispensed through said tubing connector, tubing and valve stem connector into a tire through a valve stem by compressing said flexible, collapsible pouch.

13. The pouch of claim 1, wherein said a collapsible and flexible pouch is formed from a plastic foil material.

14. The pouch of claim 1, wherein said a collapsible and flexible pouch is formed from a material select from the group of metal, alloy and plastic foil materials.
